(19) United States
(12) Patent Application Publication
(10) Pub. No.: US 2026/0201926 A1
(43) Pub. Date: Jul. 16, 2026

(54) HUBCAP WITH OIL FILTER

(71) Applicant: Adam Price, Springfield, OH (US)

(72) Inventor: Adam Price, Springfield, OH (US)

(21) Appl. No.: 19/019,507

(22) Filed: Jan. 14, 2025

(51) Int. Cl. F16C 33/66

(52) U.S. Cl. CPC F16C 33/667; F16C 2326/02

(57) ABSTRACT

A hubcap assembly is configured to be mounted onto a wheel hub and has a body that forms an oil enclosure for containing oil to lubricate wheel bearings. The hubcap assembly includes an integrated filtration assembly that is positioned inside the oil enclosure and is designed to remove at least one type of contaminant from the oil contained in the oil enclosure. The filtration assembly may include magnetic components for magnetic separation of metal shavings contained in the oil. The filtration assembly may also include barrier filtration media for removal of other contaminants from the oil, or the assembly may include a combination of magnetic components and barrier filtration media.

### FIELD OF THE DISCLOSURE

The present disclosure relates to hubcap assemblies for vehicle wheels, and more particularly to a hubcap assembly with an integrated oil filter for filtering oil for wheel bearings.

### BACKGROUND

Hubcaps have long been used on vehicle wheels to protect wheel components and provide an aesthetically pleasing appearance. In heavy-duty vehicle applications, such as large trucks and trailers, hubcaps are often designed for the specific function of containing lubricating oil for wheel bearings. These oil-containing hubcaps have an oil reservoir to hold a supply of oil that lubricates the wheel bearings during operation of the vehicle. While oil lubrication can extend the life of wheel bearings compared to grease lubrication, the oil in the hubcap reservoir can become contaminated over time. Metal particles, dirt, debris, and other contaminants can accumulate in the oil as the bearings wear or as external elements enter the hubcap. This contamination can reduce the effectiveness of the lubrication and potentially lead to increased wear or damage to the bearings. Periodic oil changes are typically performed to remove contaminated oil and replenish the oil reservoir with fresh oil. However, this maintenance task requires time and labor and results in vehicle downtime. There is a general desire in the industry to extend the intervals between oil changes while still maintaining proper lubrication of wheel bearings.

Filtration is a common technique used in other lubrication systems for vehicles, such as engine oil systems, or other types of motors used in various applications to remove contaminants and extend the useful life of the lubricating oil. However, the use of filtration systems in oil-containing hubcaps is generally lacking in the industry. Integrating effective filtration into the limited space of a wheel hubcap presents challenges. Any filtration system added to a hubcap must be compact but also capable of effectively filtering various types of contaminants from the oil while maintaining proper bearing lubrication. Such a filtration system should also be durable to withstand harsh operating conditions, easy to install and remove from the hubcap, and configured to allow sufficient oil flow throughout the interior of the hubcap. Such improvements have the potential to extend oil change intervals, reduce maintenance costs, and improve overall wheel-end reliability for heavy-duty vehicles.

### SUMMARY

In one aspect, a hubcap assembly is provided. The hubcap assembly comprises a hubcap body configured to be mounted onto a wheel hub and a cap assembly configured to cap an open distal end of the hubcap body. The hubcap body has an interior wall that defines an oil enclosure that contains oil to lubricate wheel bearings. The wheel bearings support a wheel hub on which a wheel is mounted. The wheel hub and wheel may be mounted onto any suitable type of axle or spindle of any type of vehicle or trailer towed by a vehicle. The hubcap body may have a generally cylindrical shape. The hubcap assembly further comprises a filtration assembly configured to remove at least one type of contaminant from the oil contained in the oil enclosure. The filtration assembly may comprise one or more magnets configured to remove metal shavings from the oil, a barrier filtration media, or a combination of magnets and barrier filtration media. The barrier filtration media is configured to remove dirt, debris, or any other type of contaminant capable of being removed through barrier filtration of oil. The filtration assembly is generally mounted onto the interior wall of the hubcap body, and a holding chamber is disposed between the filtration assembly and the cap assembly at the distal end of the hubcap assembly.

In a preferred embodiment, the filtration assembly comprises at least one baffle plate and may comprise two opposing baffle plates. The baffle plates may be removably attached to the interior wall of the hubcap body at a position that is axially inward from the cap assembly. Each of the baffle plates has a plurality of openings extending through the baffle plate. Each baffle plate generally extends transversely across a width of the oil enclosure between surfaces of the interior wall on opposing sides of the oil enclosure with the holding chamber being disposed between the most distally positioned baffle plate and the cap assembly. The hubcap assembly preferably further comprises a magnet disposed between the two baffle plates. Alternatively, the hubcap assembly may comprise barrier filtration media disposed between the baffle plates, or the assembly may comprise both a magnet and barrier filtration media disposed between the baffle plates. The magnet may be a ring-shaped magnet having an opening extending through the magnet. The magnet may be retained in a fixed position between the baffle plates by spacer elements attached to each of the baffle plates.

In one embodiment, the filtration assembly may comprise a unitary baffle assembly that may be installed into the hubcap body and removed from the hubcap body as a single unit. The baffle assembly may comprise two opposing baffle plates disposed generally parallel to each other and a sidewall extending between the two baffle plates and attaching the baffle plates to each other. The sidewall may be a continuous sidewall extending around an outer peripheral edge of each of the two baffle plates to form a generally cylindrical baffle assembly. The baffle assembly may further comprise a magnet or barrier filtration media, or both, disposed between the opposing baffle plates.

In one embodiment, the filtration assembly may comprise a generally flat baffle element and a plurality of ring-shaped magnets each attached to the baffle element and each having an opening extending through the ring-shaped magnet. Each opening extending through a respective one of the plurality of ring-shaped magnets may define a respective one of a plurality of openings extending through the baffle plate. Alternatively, at least one baffle plate may comprise a generally flat baffle element and a plurality of magnetic elements attached to an exterior surface of the baffle element.

In one embodiment, the filtration assembly may comprise a magnetic mesh filter comprising a plurality of woven wires. The magnetic mesh filter has a plurality of openings extending through the mesh filter for filtering out contaminants and may be removably attached to the interior wall of the hubcap body at a position that is axially inward from the cap assembly. The magnetic mesh filter extends transversely across a width of the oil enclosure between surfaces of the interior wall on opposing sides of the oil enclosure, and the holding chamber is disposed between the magnetic mesh filter and the cap assembly. In one embodiment, the filtration assembly may include two opposing mesh filters and may have additional barrier filtration media disposed between the mesh filters.

The cap assembly may comprise a fastening ring, a transparent viewing window having an opening extending through the viewing window, and a plug configured to be installed within the opening in the viewing window to seal the opening. The plug may have a pressure relief opening extending through the plug. The hubcap body may have helical threads configured to mate with helical threads on the wheel hub for mounting the hubcap body onto the wheel hub. Alternatively, the hubcap body may have a mounting flange having a plurality of openings extending through the mounting flange for fastening the mounting flange to the wheel hub.

The filtration assembly, including baffle plates, barrier filtration, magnetic material, or any combination thereof, has openings that define passageways that allow the flow of oil between the oil enclosure on the proximal side of the filtration assembly and the holding chamber on the distal side of the filtration assembly. The transparent viewing window allows a user to view an oil level within the holding chamber from an exterior of the hubcap. As oil moves within the interior of the hubcap body and through the filtration assembly during operation of the vehicle, the filtration assembly removes contaminants from the oil and retains the contaminants on or within the filtration assembly. The filtration assembly preferably extends transversely across substantially all of a cross-sectional area of the oil enclosure, though the hubcap assembly may be designed to provide a small gap between the filtration assembly and the interior wall of the oil enclosure to ensure oil can flow into the holding chamber in the event that the filter becomes clogged. The design of the filtration assembly effectively removes contaminants from the oil to extend the life of the oil between oil changes and thus enhance bearing lubrication through extended periods of use.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a wheel hub assembly with a hubcap in accordance with the present disclosure.

FIG. 2 shows a perspective view of a hubcap assembly for installation on a wheel hub in accordance with the present disclosure.

FIG. 3 shows a perspective view of an alternative embodiment of a hubcap assembly for installation on a wheel hub in accordance with the present disclosure.

FIG. 4 shows a side view of a hubcap assembly for installation on a wheel hub in accordance with the present disclosure.

FIG. 5 shows an exploded view of a hubcap assembly in accordance with the present disclosure.

FIG. 6 shows a cross-sectional view of a hubcap assembly in accordance with the present disclosure.

FIG. 7 shows a plan view of a baffle plate of a hubcap assembly in accordance with the present disclosure.

FIG. 8 shows a side view of a baffle plate of a hubcap assembly in accordance with the present disclosure.

FIG. 9 shows a side view of a filtration assembly of a hubcap assembly in accordance with the present disclosure.

FIG. 10 shows a perspective view of a baffle plate of a hubcap assembly in accordance with the present disclosure.

FIG. 11 shows a plan view of a baffle plate of a hubcap assembly in accordance with the present disclosure.

FIG. 12 shows an exploded view of a baffle plate of a hubcap assembly in accordance with the present disclosure.

FIG. 13 shows a cross-sectional view of a hubcap assembly in accordance with the present disclosure.

FIG. 14 shows a perspective view of a filtration assembly of a hubcap assembly in accordance with the present disclosure.

FIG. 15 shows a side view of a filtration assembly of a hubcap assembly in accordance with the present disclosure.

FIG. 16 shows a perspective view of a woven mesh filter of a hubcap assembly in accordance with the present disclosure.

FIG. 17 shows a side view of a filtration assembly of a hubcap assembly in accordance with the present disclosure.

FIG. 18 shows a side view of a filtration assembly of a hubcap assembly in accordance with the present disclosure.

FIG. 19 shows a perspective view of a filtration assembly of a hubcap assembly in accordance with the present disclosure.

FIG. 20 shows a perspective view of a filtration assembly of a hubcap assembly in accordance with the present disclosure.

FIG. 21 shows a plan view of a filtration assembly of a hubcap assembly in accordance with the present disclosure.

FIG. 22 shows a cross-sectional view of a hubcap assembly in accordance with the present disclosure.

FIG. 23 shows a cross-sectional view of a filtration assembly of a hubcap assembly in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

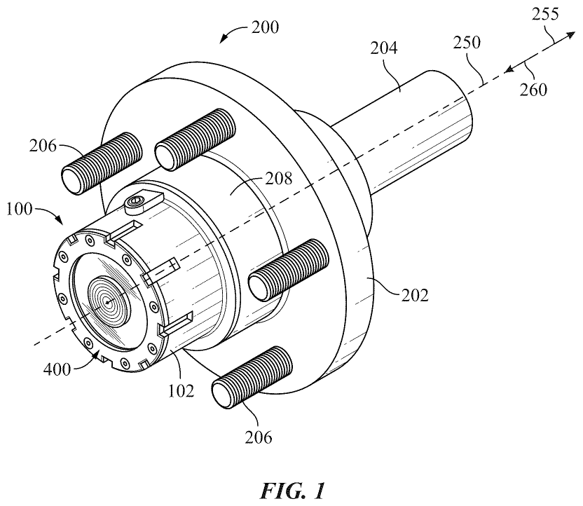

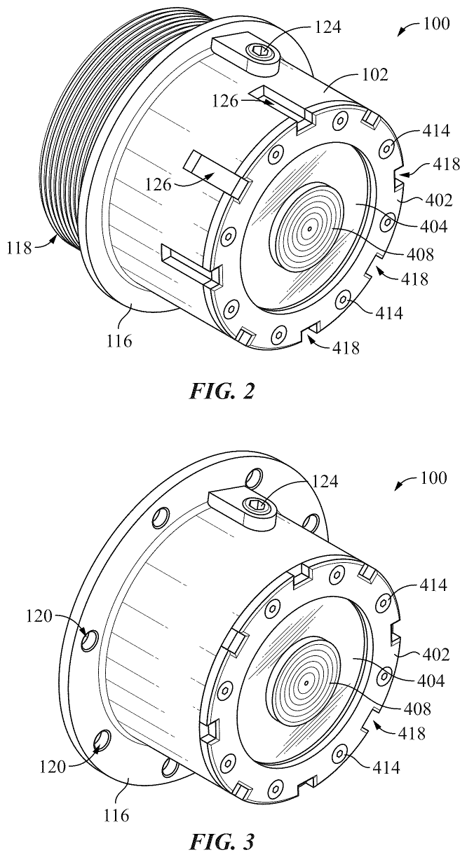

In one aspect, a hubcap assembly 100 is provided. The hubcap assembly 100 comprises a hubcap body 102 configured to be mounted onto a wheel hub 202. FIG. 1 shows a wheel hub assembly 200 with the hubcap assembly 100 installed thereon, and FIGS. 2-4 show the hubcap assembly 100 removed from the wheel hub assembly 200. The hubcap body 102 has an interior wall 104 that defines an oil enclosure 108 that contains oil to lubricate wheel bearings. The hubcap assembly 100 further comprises a filtration assembly 300 configured to remove at least one type of contaminant from the oil contained in the oil enclosure 108. The hubcap assembly 100 may further comprise a cap assembly 400 configured to cap an open distal end 112 of the hubcap body 102.

The wheel hub assembly 200 may comprise the wheel hub 202 rotatably coupled to and positioned around an axle 204 of a vehicle. The hub 202 is supported on the axle 204 by at least one bearing so that the hub 202 and wheel mounted thereon may rotate about the axle 204. As used herein, an “axle” may refer to any component of a vehicle that provides a structure for rotatably coupling a wheel hub 202 thereto. The vehicle may include any type of motorized or non-motorized vehicle having wheels that may be used for transporting people or goods, including, but not limited to, motorized vehicles such as a tractor unit of a semi-trailer or tractor-trailer, dump trucks, buses, cars, recreational vehicles (RV), motor homes, or electric conveyance vehicles (ECV), and non-motorized vehicles such as a trailer or semi-trailer, which may include enclosed cargo trailers, flatbed trailers, boat trailers, vehicle trailers, livestock trailers, or dollies. The wheel hub 202 may have outwardly facing bolts 206 for mounting a wheel on the hub 202. The hub 202 rotates about a central axis 250 when the vehicle is in motion so that the wheel mounted on the hub 202 rotates with the hub 202. As used herein, an axially inward direction refers to a direction extending toward the axle 204, and an axially outward direction refers to a direction extending away from the axle 204 toward the cap assembly 400 that is accessible from the exterior of the hubcap assembly 100. As illustrated in FIG. 1, arrow 255 indicates an axially inward direction, and arrow 260 indicates an axially outward direction. As used herein, a “distal” end or “distal” side of any component of the hubcap assembly 100 or a “distal” direction refers to an end, side, or direction toward the axially outward direction 260. Similarly, a “proximal” end or “proximal” side of any component of the hubcap assembly 100 or a “proximal” direction refers to an end, side, or direction toward the axially inward direction 255.

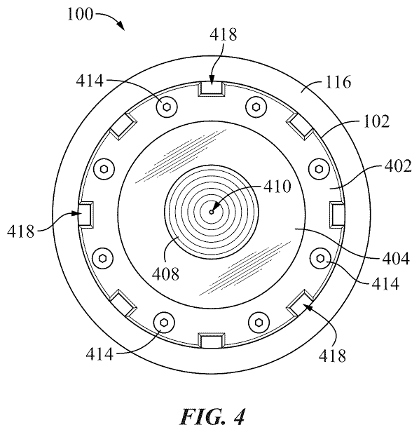

The wheel hub 202 may have a hubcap assembly 100 mounting portion 208 that extends axially outward from the hub 202, as shown in FIG. 1. The mounting portion 208 of the hub 202 preferably has helical female threads configured to mate with helical male threads 118 attached to the hubcap body 102, as best seen in FIG. 2. FIG. 1 shows the male threads 118 fully threaded into the mounting portion 208 of the hub 202 to mount the hubcap body 102 onto the wheel hub 202. To facilitate installing the threaded hubcap body 102 of the hubcap assembly 100 on the wheel hub 202 and removing the hubcap body 102 from the wheel hub 202, the hubcap body 102 may have a plurality of elongated channels 126 formed into the hubcap body 102 on an exterior surface of the hubcap body, as best seen in FIGS. 2 and 4. The elongated channels 126 may be equidistantly spaced around a perimeter of the hubcap body 102 and may be designed for use with a specialized wrench configured to engage the hubcap body 102 at each of the elongated channels 126 to apply torque to the hubcap body 102 to thread the hubcap body 102 onto or off of the mounting portion 208 of the wheel hub 202. Alternatively, the hubcap body 102 or portions thereof may have other shapes suitable for engaging with a wrench for applying torque for installation or removal of the threaded hubcap body 102. In an alternative embodiment, as shown in FIG. 3, the hubcap body 102 may have a mounting flange 116 having a plurality of openings 120 extending through the mounting flange 116 for fastening the mounting flange 116 to the wheel hub 202. In this embodiment, the wheel hub 202 may have corresponding threaded bolt holes for fastening the mounting flange 116 onto the wheel hub 202 using bolts inserted through the openings 120 and into the bolt holes of the hub 202. In this embodiment, the hub 202 may or may not include elongated channels 126.

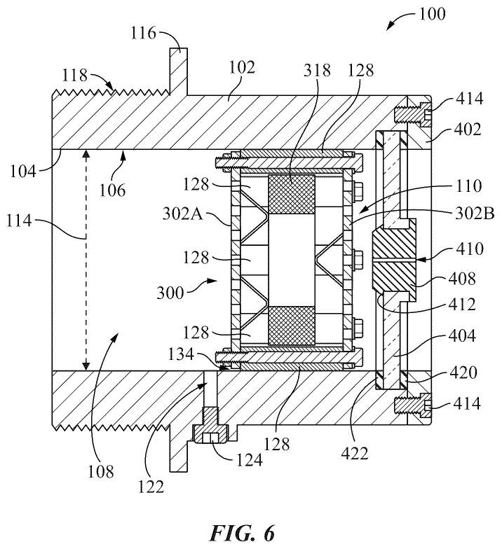

The hubcap body 102 may have a generally cylindrical shape, as best seen in FIGS. 2-4. Alternatively, the hubcap body 102 may have other suitable shapes. For instance, the hubcap body 102 may be tapered as the body 102 extends toward the distal end 112, in which case the body 102 may have a truncated conical shape. The hubcap body 102 is generally a housing having a continuous sidewall that forms the oil enclosure 108. As best seen in FIGS. 4 and 6, an interior side of the sidewall of the body 102 forms the interior wall 104, which has an interior surface 106 that extends continuously around a perimeter of the oil enclosure 108. The filtration assembly 300 is disposed within the oil enclosure 108, and a portion of the oil enclosure 108 that is disposed on a distal side of the installed filtration assembly 300 defines a holding chamber 110, as shown in FIGS. 6, 13, and 22. Thus, the holding chamber 110 portion of the oil enclosure 108 is disposed between the filtration assembly 300 and the cap assembly 400. The holding chamber 110 is a space that may hold a portion of the oil contained within the oil enclosure 108 and allows the oil to flow across the filtration assembly 300. The filtration assembly 300 extends transversely across a width 114 of the oil enclosure 108 between interior surfaces 106 of the interior wall 104 on opposing sides of the oil enclosure 108, preferably around a circular perimeter of the oil enclosure 108. As best seen in FIG. 6, the filtration assembly 300 may preferably extend transversely across a maximum width 114 of the oil enclosure 108. The filtration assembly 300 is preferably disposed in a position generally perpendicular to the interior wall 104 of the hubcap body 102. Preferably, the filtration assembly 300, or components thereof, has a generally circular shape that defines an outer peripheral edge 306 of the filtration assembly 300, and the outer peripheral edge 306 of the filtration assembly 300 generally conforms to a generally circular interior shape of the interior wall 104 of the oil enclosure 108 such that the filtration assembly 300 extends transversely across substantially all of a cross-sectional area of the oil enclosure 108, as best seen in FIG. 6. However, the filtration assembly 300 preferably has an outer diameter that is slightly smaller than an inner diameter 114 of the oil enclosure 108 such that there is a small gap 134 between the filtration assembly 300 and the interior surface 106 of the interior wall 104 of the hubcap body 102 around a perimeter of the filtration assembly 300 to allow a minimal amount of oil within the oil enclosure 108 to bypass the filtration assembly 300 through the gap 134 to ensure that oil can move between the holding chamber 110 and portions of the oil enclosure 108 on the proximal side of the filtration assembly 300 in the event that the filtration assembly 300 becomes clogged after a period of use. Thus, the filtration assembly 300, or components thereof, may generally extend between opposing interior surfaces 106 of wall 104, but may not directly contact the interior surfaces 106 of the wall 104 when installed. The gap 134 may thus allow oil levels in the enclosure 108 to equalize on opposite sides of the filtration assembly 300, if necessary, though the majority of the oil that passes between the holding chamber 110 and the oil enclosure 108 on the proximal side of the filtration assembly 300 would pass through the filtration assembly 300 during normal operation of the vehicle.

As best seen in FIG. 6, the hubcap body 102 may have a drain port 122 that is closed during normal use by a drain plug 124. The drain port 122 may define a threaded opening having threads that are compatible with threads on the drain plug 124 to allow the drain plug 124 to seal the drain port 122 closed and to remove the drain plug 124 to drain oil from the oil enclosure 108 to periodically change the oil. The drain port 122 is preferably positioned on a proximal side of the filtration assembly 300. Fresh oil may also be added into the oil enclosure 108 through the drain port 122 after draining the used oil.

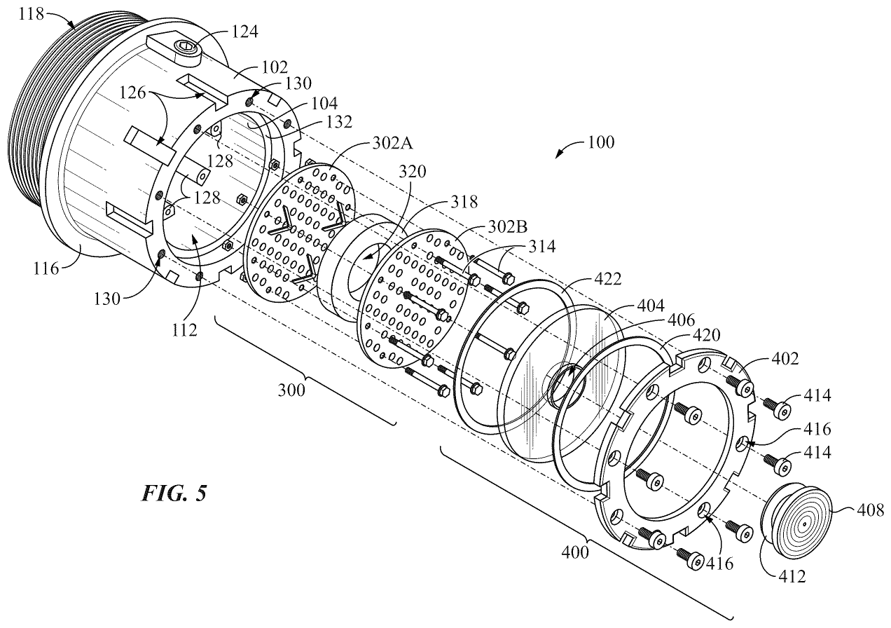

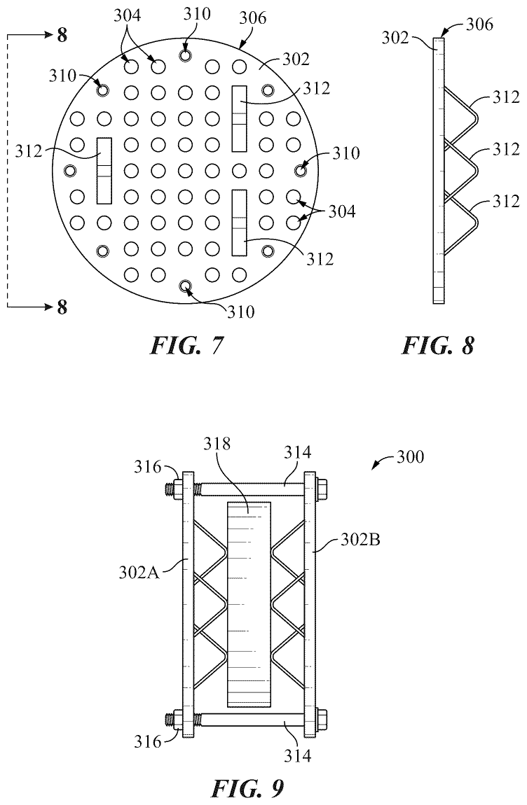

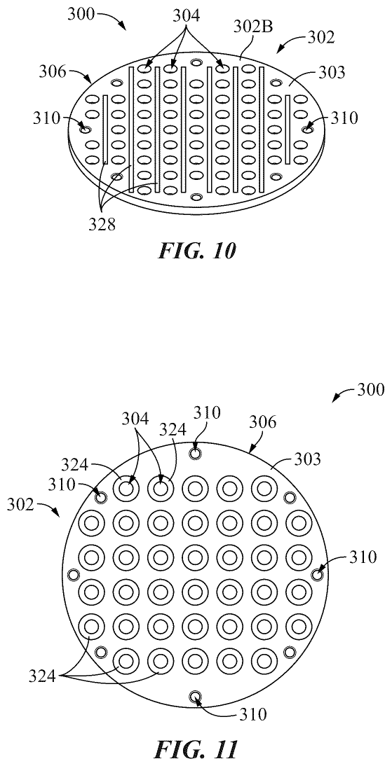

FIG. 5 shows an exploded view of the hubcap assembly 100 utilizing one embodiment of the filtration assembly 300. It should be understood by one of skill in the art that other embodiments of the filtration assembly 300 may be utilized and still fall within the scope of the present disclosure. FIGS. 7-9 illustrate the filtration assembly 300 shown in FIG. 5. FIGS. 10-22 show additional embodiments, or components thereof, of the filtration assembly 300 removed from the hubcap body 102 or installed within the hubcap body 102. FIGS. 5-6, 13, and 22 show the filtration assembly 300 installed on the hubcap body 102 utilizing threaded fasteners 314. It should be further understood by one of skill in the art that different installation mechanisms may be utilized to retain the filtration assembly 300 in a fixed position within the oil enclosure 108 and still fall within the scope of the present disclosure. For instance, various types of clips, clamps, pins, snap-on fasteners, quick-connect fasteners, or any other suitable type of fastener may be alternatively utilized to retain the filtration assembly 300 in place without departing from the scope of the present disclosure.

The filtration assembly 300 may comprise one or more magnets 318, 324, 328, 340 configured to remove metal shavings from the oil, a barrier filtration media 322, 322A, or a combination of magnets and barrier filtration media. The barrier filtration media 322 is configured to remove dirt, debris, or any other type of contaminant capable of being removed through barrier filtration of oil. The filtration assembly 300 is generally mounted onto the interior wall 104 of the hubcap body 102 so that the one or more magnets or filtration media 322, or portions thereof, or other structural components, which may include one or more baffle plates 302 to which magnets may be attached or by which filtration media may be contained, extends transversely across the width 114 of the oil enclosure 108 between interior surfaces 106 on opposing sides of the enclosure 108.

In a preferred embodiment, the filtration assembly 300 comprises at least one baffle plate 302 attached to the interior wall 104 of the hubcap body 102 at a position that is axially inward 255 from the cap assembly 400. The filtration assembly 300 is preferably removably attached to the interior wall 104 to allow removal of the filtration assembly 300 form the hubcap body 102. In some embodiments, the filtration assembly 300 may comprise more than one baffle plate 302, and may comprise a pair of baffle plates 302 including a proximal baffle plate 302A and a distal baffle plate 302B. Each of the baffle plates 302 has a plurality of openings 304 extending through the baffle plate 302 to allow oil to flow through the baffle plates 302. Each baffle plate 302 generally extends transversely across the width 114 of the oil enclosure 108 between the interior surfaces 106 on opposing sides of the oil enclosure 108 with the holding chamber 110 being disposed between the distal baffle plate 302B and the cap assembly 400. In some embodiments, as best seen in FIGS. 10-12, one or more baffle plates 302 may have magnets 324, 328 attached directly to the baffle plate 302. In other embodiments, each baffle plate 302 may be constructed of non-magnetic materials, which may preferably be a metal or plastic material. Each baffle plate 302 preferably comprises a generally flat plate having a generally circular shape.

In a preferred embodiment, as shown in FIGS. 5 and 6, the hubcap assembly 100 may comprise a magnet 318 disposed between two opposing baffle plates 302A and 302B. The magnet 318 may be a ring-shaped magnet having an opening 320 extending through the magnet 318, which may further allow oil flow through the filtration assembly 300. FIG. 9 shows the filtration assembly 300 removed from the hubcap assembly 100 with magnet 318 disposed between baffle plates 302A and 302B and with fasteners 314 and 316 fastening the filtration assembly 300 together. The baffle plates 302A and 302B are preferably disposed generally parallel to each other.

The magnet 318 may be retained in a fixed position between the baffle plates 302A and 302B by spacer elements 312 attached to each of the baffle plates 302. Each baffle plate 302 may have a plurality of spacer elements 312 each extending from a surface of each of the opposing baffle plates 302A and 302B toward the magnet 318 so that the spacer elements 312 hold the magnet 318 at a distance from the baffle plate 302, the distance being defined by the distance that each of the spacer elements 312 extends from the baffle plate 302. As shown in FIGS. 5 and 9, each of the spacer elements 312 may extend in an outward direction 260 from baffle plate 302A and in an inward direction 255 from baffle plate 302B. The magnet 318 may be retained in a fixed position only by the spacer elements 318 contacting the magnet 318 on opposing sides of the magnet 318 after installation of the assembly 300 and without any additional fastening mechanism directly securing the magnet 318. In one embodiment, as best seen in FIGS. 7 and 8, each baffle plate 302 may include three spacer elements 312 positioned to contact the ring-shaped magnet 318 at three points on each of the two opposing sides of the magnet 318 to securely retain the magnet 318 in place. The spacer elements 312 may be welded to the baffle plates 302 or otherwise integrally attached to the baffle plates 302. Once the filtration assembly 300 is installed within the oil enclosure 108, the openings 304 in each of the baffle plates 302, the opening 320 in the magnet 318, and the spacing between the magnet 318 and baffle plates 302 may allow oil to flow across the filtration assembly 300 during normal operation of the vehicle. When the oil flows through the filtration assembly 300, the oil comes into contact with the magnet 318, which magnetically attracts any metal shavings present in the oil, thereby providing magnetic filtration of any metallic debris from the oil.

To install the filtration assembly 300 within the oil enclosure 108, the hubcap body 102 may include a plurality of bolt receivers 128 each attached to the interior wall 104 of the hubcap body 102 at spaced intervals around an interior perimeter of the oil enclosure 108. Three of the plurality of bolt receivers 128 can be seen in FIG. 5. Each bolt receiver 128 has an opening sized to receive a bolt 314 therein for fastening the filtration assembly 300 to the interior wall 104 of the hubcap body 102. As best seen in FIG. 6, the opening in each of the bolt receivers 128 may extend through the bolt receiver 128 so that the bolt 314 can be inserted through the opening, and a compatible nut 316 may be threaded onto a threaded end of the bolt 314 to fasten the filtration assembly 300 to the hubcap body 102. Each baffle plate 302 may have corresponding openings 310 sized to insert one of the bolts 314 through each opening 310. FIGS. 5-7 show an embodiment of the hubcap assembly 100 utilizing eight bolts 314 with eight bolt receivers 128. It should be understood that a different number of bolts 314 and bolt receivers 128 may be utilized.

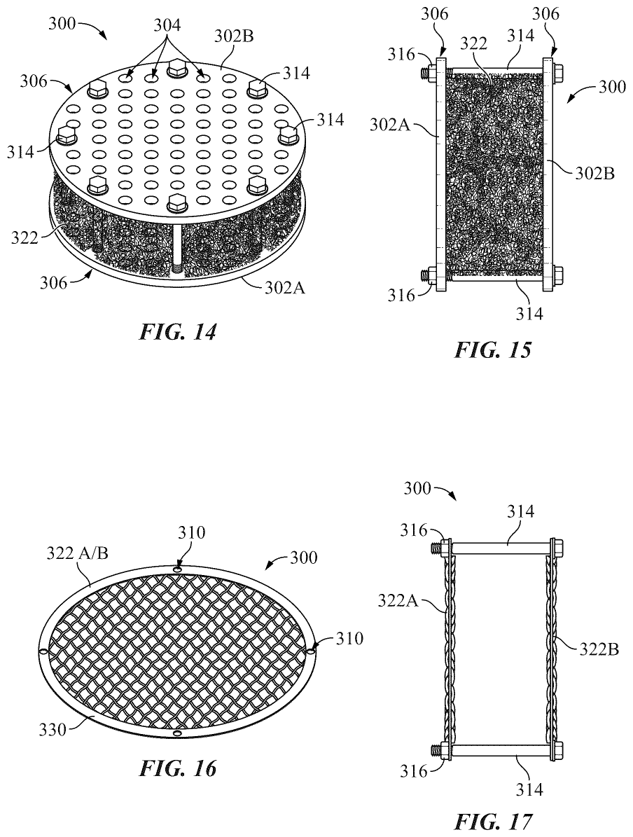

In other embodiments, as shown in FIGS. 14-23, the filtration assembly 300 may comprise barrier filtration media 322. Barrier filtration may be provided by a depth filter 322 or a surface filter 322A, 322B. As best seen in FIGS. 14 and 15, the barrier filtration media 322 may be disposed between two opposing baffle plates 302A and 302B. When installed, the barrier filtration 322 may preferably extend transversely across substantially all of a cross-sectional area of the oil enclosure 108. The barrier filtration media 322 may comprise any type of filtration media suitable for physical removal of contaminants such as dirt and debris from oil contained within a wheel hub for lubricating wheel bearings. The barrier filtration media 322 may be a depth filter having a density that provides passageways having a size through which the oil may flow through the media 322 and between the oil enclosure 108 on the proximal side of the filtration assembly 300 and the holding chamber 110 on the distal side of the filtration assembly 300 during operation of the vehicle, thereby filtering contaminants from the oil. In some embodiments, the barrier filtration media 322 may comprise a wire wool material, such as stainless steel wool, or a similar type of filtration material comprising entwined filaments that are agglomerated to form a depth filter having passageways capable of retaining various types of contaminants throughout the filtration media. Due to the agglomerated nature of the entwined filaments, the sizes of the passageways formed by the filaments throughout the media 322 may vary. In some embodiments, the barrier filtration media 322 may have internal passageways having sizes or diameters generally in the range of 1 to 2,000 microns, and preferably in the range of approximately 25 to 750 microns. In some embodiments, the barrier filtration media 322 may comprise cellulose fibers, synthetic glass fibers, polyester fibers, or other types of natural or synthetic fibers. In some embodiments, the barrier filtration media 322 may comprise layers of stainless steel wire cloth. In some embodiments, the filtration media 322 may comprise material that is pleated or material that is sintered. In some embodiments, the barrier filtration media 322A, 322B may comprise a surface filter, such as a sieve or mesh, rather than a depth filter. In some embodiments, the surface filter may have pore sizes up to about 2,000 microns and preferably ranging from about 25 to 750 microns.

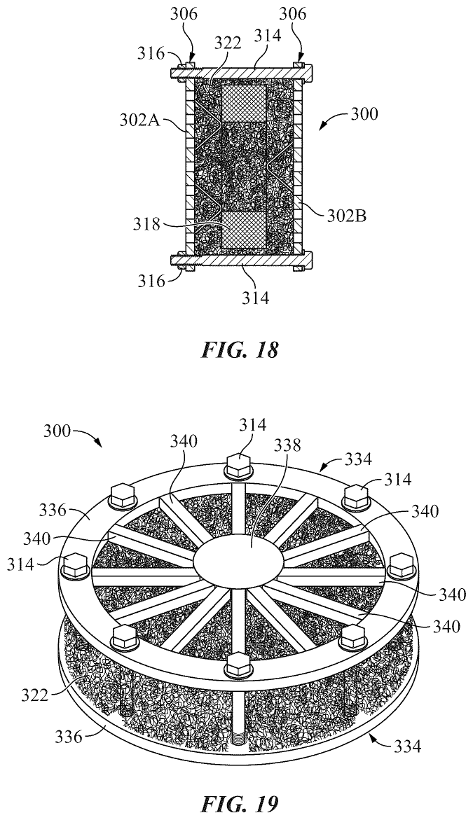

Alternatively, as shown in FIG. 18, which shows a cross-section of the filtration assembly 300, the filtration assembly 300 may comprise both a magnet 318 and barrier filtration media 322. In this embodiment, spacer elements 312 may be utilized to retain the magnet 318 in a fixed position between baffle plates 302A and 302B, and the barrier filtration media 322 may be disposed in voided areas surrounding the magnet 318 and between the baffle plates 302A and 302B. In this case, the filtration assembly 300 may be used to effectively remove both metal shavings and other ferromagnetic particles as well as non-metallic contaminants from the oil.

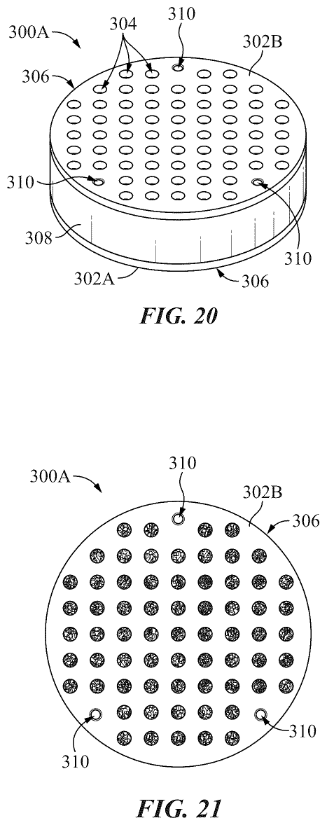

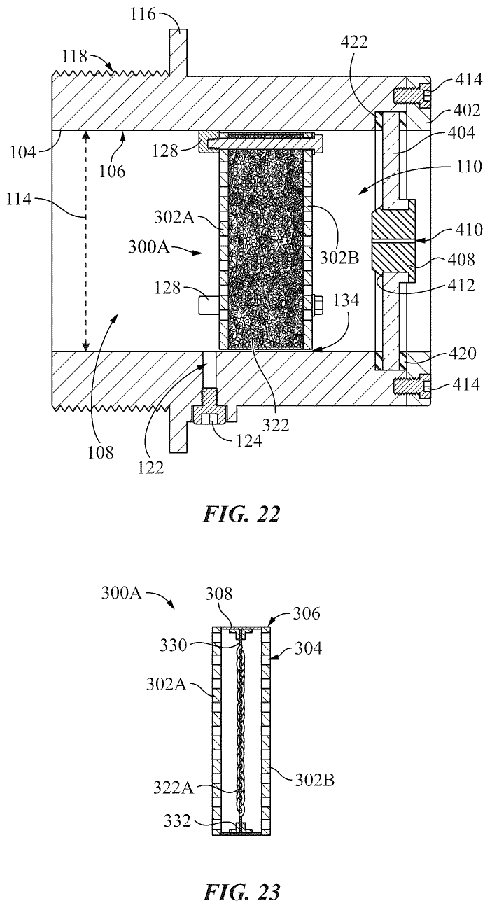

In other embodiments, as shown in FIGS. 20-23, the filtration assembly 300 may comprise a unitary baffle assembly 300A including magnetic and/or barrier filtration in the form of a single cartridge that may be installed inside the hubcap body 102 and removed from the hubcap body 102 as a single unit 300A without disconnecting or detaching any components of the unit 300A from each other. This may allow faster removal of a used baffle assembly 300A and replacement with a new baffle assembly 300A to minimize downtime of a vehicle. The baffle assembly 300A may comprise two opposing baffle plates 302A, 302B disposed generally parallel to each other and a sidewall 308 extending between the two baffle plates 302A, 302B and attaching the baffle plates 302A, 302B to each other. The sidewall 308 may be a continuous sidewall 308 extending around an outer peripheral edge 306 of each of the two circular baffle plates 302A, 302B to form a generally cylindrical baffle assembly 300A. The baffle assembly 300A may further comprise a magnet 318 or barrier filtration media 322, or both, disposed between the opposing baffle plates 302A, 302B. The embodiments shown in FIGS. 20-23 utilize only barrier filtration media 322, 322A. The filtration media 322, 322A may be pre-installed within the baffle assembly 300A, and each of the baffle plates 302 may be welded to the sidewall 308 or otherwise integrally attached to the sidewall 308 to form the unitary assembly 300A. Alternatively, one of the baffle plates 302 may have threads, and the sidewall 308 may also have threads that are compatible with the threads of the baffle plate 302 so that the baffle plate 302 can be removed from the assembly 300A by rotating the baffle plate 302 to disengage the threads. This may allow the filtration media 322, 322A to be removed and replaced so that the baffle assembly 300A can be reused. As best seen in FIG. 21, the baffle assembly 300A may have a plurality of bolt openings 310 that extend entirely through the assembly 300A, including through the filtration media 322. Bolts 314 may be inserted through the baffle assembly 300A and used to fasten the assembly 300A to the interior wall 104 of the hubcap body 102. As shown in FIG. 22, the hubcap body 102 may include corresponding bolt receivers 128, which may have threaded openings that are compatible with threads on the bolts 314. In this case, the bolt receivers 128 may have a relatively shorter length since the bolts 314 do not extend entirely through the bolt receivers 128.

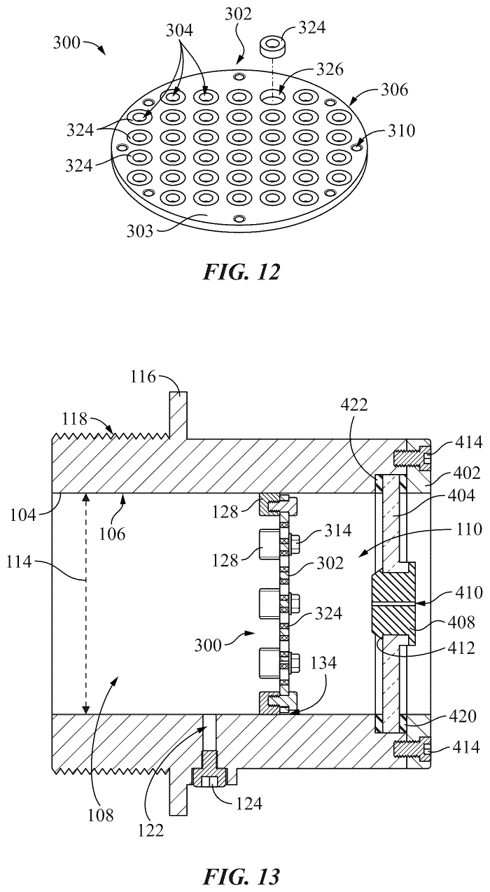

In some embodiments, as best seen in FIG. 13, the filtration assembly 300 may comprise only a single baffle plate 302 that includes magnetic elements for removal of ferromagnetic contaminants primarily. In one embodiment, as shown in FIGS. 11 and 12, the baffle plate 302 of the filtration assembly 300 may comprise a generally flat baffle element 303 and a plurality of ring-shaped magnets 324 each attached to the baffle element 303 and each having an opening extending through the ring-shaped magnet 324. Each opening extending through a respective one of the plurality of ring-shaped magnets 324 may define a respective one of a plurality of openings 304 extending through the baffle plate 302. FIG. 12 shows an exploded view of the filtration assembly 300 with a single magnet 324 removed from the baffle plate 302. The baffle element 303 may be a generally circular disc having a plurality of circular openings 326 sized to receive a respective one of the ring-shaped magnets 324 therein. When installed within one of the openings 326, surfaces on opposing sides of each of the ring-shaped magnets 324 may be generally flush with exterior surfaces on opposing sides of the baffle element 303. Each of the ring-shaped magnets 324 may be press-fit into one of the openings 326 in the baffle element 303 or otherwise attached to the baffle element 303. The openings 304 defined by the magnets 324 and extending through the assembled baffle plate 302 allow the oil to flow across the filtration assembly 300 while increasing the surface area that contacts the oil for magnetic separation of ferromagnetic contaminants from the oil.

Alternatively, as shown in FIG. 10, the baffle plate 302 of the filtration assembly 300 may comprise a generally flat baffle element 303 and a plurality of magnetic elements 328 attached to the baffle element 303. The magnetic elements 328 may comprise sheets of magnetic material formed into strips and attached to the surface of the baffle element 303 on at least one side of the baffle element 303, and preferably on at least the proximal side of the baffle element 303 when the baffle plate 302 is installed within the oil enclosure 108. The magnetic strips 328 may be positioned on the surface of the baffle element 303 in rows between rows of openings 304 in the baffle element 302. The openings 304 extending through the baffle plate 302 allow the oil to flow across the filtration assembly 300 while the oil also contacts the magnetic strips 328 for magnetic separation of ferromagnetic contaminants.

In one embodiment, as shown in FIG. 16, the filtration assembly 300 may comprise a mesh filter 322A comprising a plurality of woven wires. The mesh filter 322A has a plurality of openings extending through the mesh and being defined by spaces between the woven wires. The mesh filter 322A may be a surface filter designed to remove contaminants from the oil as the oil passes through the openings in the mesh. The mesh filter 322A may be removably attached to the interior wall 104 of the hubcap body 102 at a position that is axially inward from the cap assembly 400. The mesh filter 322A may extend transversely across the width 114 of the oil enclosure 108 between interior surfaces 106 of the interior wall 104 on opposing sides of the oil enclosure 108. The mesh filter 322A may have a rim 330 around a perimeter edge of the mesh filter 322A, and the rim 330 may have openings 310 for fastening the mesh filter 322A to the hubcap body 102 using bolts 314 or similar fasteners. When installed, the holding chamber 110 is disposed between the mesh filter 322A and the cap assembly 400.

In one embodiment, the mesh filter 322A may be a magnetic mesh filter comprising a plurality of woven wires. The wires forming the mesh may be made of material have magnetic characteristics such that the mesh filter 322A produces a magnetic field capable of attracting ferromagnetic particles contained in the oil. For instance, the wires forming the mesh may be made of a magnetic stainless steel, such as ferritic stainless steel, martensitic stainless steel, or duplex stainless steel. The magnetic stainless steel may be an alloy including ferritic or martensitic crystal structures to provide magnetic properties, such as 430 grade stainless steel. In alternative embodiments, one or both of the baffle plates 302A, 302B may be made of magnetic stainless steel or a similar material having magnetic characteristics rather than utilizing separate magnets 324, 328 attached to baffle element 303 or disposed between opposing baffle plates 302.

In one embodiment, as shown in FIG. 17, the filtration assembly 300 may comprise two opposing surface mesh filters 322A and 322B spaced apart from each other and each comprising a plurality of woven wires. In this embodiment, the holding chamber 110 is disposed between the distally or outwardly positioned mesh filter 322B and the cap assembly 400. One or both of the surface mesh filters 322A and 322B may be made of material having magnetic characteristics, such as magnetic stainless steel. Barrier filtration media 322 in the form of a depth filter may optionally be disposed between the two opposing surface mesh filters 322A and 322B.

In one embodiment, the filtration assembly 300 may comprise a coated mesh filter 322B, which may be used in combination with magnetic or non-magnetic mesh filter 322A. The coated mesh filter 322B is preferably disposed between mesh filter 322A and the cap assembly 400. The coated mesh filter 322B comprises a plurality of woven wires coated with a hydrophobic material configured to allow the passage of oil through the openings of the coated mesh filter 322B and to prevent the passage of water through the coated mesh filter 322B. For instance, the wires forming the woven mesh filter 322B may be coated with a polytetrafluoroethylene (PTFE) resin or a similar hydrophobic material to provide a hydrophobic filter element that separates oil from any water that may have contaminated the oil. When utilized in combination with additional mesh filter 322A, mesh filter 322B is preferably disposed on the distal or outward side of mesh filter 322A. In this case, any aqueous contaminant that may enter the holding chamber 110 through any component of the cap assembly 400, for instance, in the case of a leak between sealed components, will not pass through mesh filter 322B into the proximal side of the oil enclosure 108, which would expose the wheel bearings to the aqueous contaminant.

In one preferred embodiment, as shown in FIG. 23, the filtration assembly 300 may comprise a unitary baffle assembly 300A comprising opposing baffle plates 302A and 302B and at least one surface mesh filter 322A disposed between the baffle plates 302A and 302B. The baffle assembly 300A may thus be in the form of a single cartridge that may be installed inside the hubcap body 102 and removed from the hubcap body 102 as a single unit 300A without disconnecting or detaching any components of the unit 300A from each other, which may allow faster removal of a used baffle assembly 300A and replacement with a new baffle assembly 300A to minimize vehicle downtime. The baffle assembly 300A may comprise a sidewall 308 extending between the two baffle plates 302A, 302B and attaching the baffle plates 302A, 302B to each other. The sidewall 308 may be a continuous sidewall 308 extending around an outer peripheral edge 306 of each of the two circular baffle plates 302A, 302B to form a generally cylindrical baffle assembly 300A. The mesh filter 322A may be made of magnetic stainless steel or a similar material having magnetic characteristics. Alternatively, the mesh filter 322A may have a hydrophobic coating. Additionally, one or both of the baffle plates 302A and 302B may be made of magnetic material or may have magnets 324, 328 attached to the baffle plate 302 to provide magnetic separation. The mesh filter 322A may be pre-installed within the baffle assembly 300A, and each of the baffle plates 302 may be welded to the sidewall 308 or otherwise integrally attached to the sidewall 308 to form the unitary assembly 300A. Alternatively, one of the baffle plates 302 may have threads, and the sidewall 308 may also have threads that are compatible with the threads of the baffle plate 302 so that the baffle plate 302 can be removed from the assembly 300A by rotating the baffle plate 302 to disengage the threads. This may allow access to the mesh filter 322A inside the cartridge so that the mesh filter 322A may be cleaned or removed and replaced so that the baffle assembly 300A can be reused. The mesh filter 322A may have a rim 330 configured to be removably secured within the interior of the baffle assembly 300A using clips 332 or another suitable type of fastener to retain the mesh filter 322A in a fixed position within the unitary baffle assembly 300A and to allow removal of the mesh filter 322A. The baffle assembly 300A may be fastened to the interior wall 104 of the hubcap body 102 using bolts 314 or another suitable type of fastener.

In one embodiment, as shown in FIG. 19, the filtration assembly 300 may comprise barrier filtration media 322 disposed between two opposing support structures 334. Each of the opposing support structures 334 comprises a plurality of magnetic elements 340 arranged with a plurality of openings between the magnetic elements 340. Each of the opposing support structures 334 may be removably attached to the interior wall 104 of the hubcap body 102 at a position that is axially inward from the cap assembly 400. In one embodiment, each of the opposing support structures 334 may comprise an outer support ring 336 and a central support node 338, and each of the plurality of magnetic elements 340 may be attached to the outer support ring 336 at one end of the magnetic element 340 and to the central support node 338 at an opposing end of the magnetic element 340. Each of the magnetic elements 340 may comprise a bar magnet. Each of the outer support rings 336 may have openings for fastening the filtration assembly 300 to bolt receivers 128 attached to the interior wall 104 of the hubcap body 102 using bolts 314.

As best seen in FIGS. 5 and 6, the cap assembly 400 may comprise a fastening ring 402, a transparent viewing window 404 having an opening 406 extending through the viewing window 404, and a plug 408 configured to be installed within the opening 406 in the viewing window 404 to seal the opening 406. The cap assembly 400 may further comprise a distal gasket 420 and a proximal gasket 422 positioned on opposite sides of the viewing window 404 to form a seal between the cap assembly 400 and the hubcap body 102. The cap assembly 400 may be installed on the hubcap body 102 or removed from the hubcap body 102 using common tools so that the filtration assembly 300 may be accessed through the distal end 112 of the hubcap assembly 100. In an alternative embodiment, components forming the cap assembly 400 may be permanently attached to the distal end of the hubcap body 102, in which case the entire hubcap body 102 may be made of a transparent material to allow visual observation of the oil contained within the hubcap body 102. In this case, the filtration assembly 300 may be accessed through the threaded end 118 after detaching the hubcap body 102 from the wheel hub 202.

With the cap assembly 400 removed from the hubcap body 102, the filtration assembly 300 or unitary assembly 300A may be installed within the oil enclosure 108. Assembly 300A or embodiments of the filtration assembly 300 utilizing a single baffle plate 302 or mesh filter 322 may be installed through the open distal end 112 of the hubcap body 102. Baffle plates 302B and 302A may optionally be installed through the distal end 112 and the opposing threaded end 118 of the hubcap body 102, respectively. The assembly 300, 300A may then be fastened to the interior of the hubcap body 102 using bolts 314 or another suitable type of fastener. The assembly 300, 300A is preferably not directly attached to any component of the cap assembly 400 and is spaced apart from the cap assembly 400 so that the space therebetween defines the holding chamber 110. The proximal gasket 422 may then be installed in the hubcap body 102. The interior wall 104 of the hubcap body 102 preferably has an interior edge 132 sized and configured so that the proximal gasket 422 may be positioned flat against the interior edge 132 when installed. The transparent viewing window 404 may then be placed against the proximal gasket 422, and the distal gasket 420 may be placed against the opposing distal side of the viewing window 404. To complete the installation of the cap assembly 400 on the hubcap body 102, the fastening ring 402 may be placed against the distal gasket 420, as shown in FIG. 6, and the fastening ring 402 may be fastened to the hubcap body 102 using bolts 414. As shown in FIG. 5, the fastening ring 402 may have bolt openings 416 for insertion of the bolts 414 therethrough, and the distal end of the hubcap body 102 may have corresponding threaded openings 130 compatible with threads on bolts 414 and configured to receive bolts 414 therein to tightly secure the installation of the cap assembly 400 so that the distal end 112 of the hubcap body 102 is sealed. As best seen in FIG. 2, the fastening ring 402 may have a plurality of notches 418 equidistantly spaced around a perimeter of the fastening ring 402 and configured to align with the plurality of elongated channels 126 on the exterior of the hubcap body 102 to allow a specialized wrench to engage the hubcap assembly 100 to apply torque for installing or removing the hubcap assembly 100.

The plug 408 may then be installed within the opening 406 in the viewing window 404 to fully complete the installation. The plug 408 may be made of a deformable elastomeric material, such as rubber or a similar polymeric material, and may have a lip 412 extending around a perimeter of a proximal end of the plug 408 to retain the plug 408 within opening 406 after insertion into the opening 406. As best seen in FIG. 6, the plug 408 may have a pressure relief opening 410 extending through the plug 408. The pressure relief opening 410 may be a slit or small borehole extending through the plug 408 to allow equalization of pressure between the interior of the hubcap body 102 and the external atmosphere while preventing or minimizing any amount of dirt, debris, or moisture that may enter the oil enclosure 108 through the opening 410 and also preventing or minimizing any potential leakage of oil from the oil enclosure 108.

Once the cap assembly 400 is fully installed, the transparent viewing window 404 allows a user to visually observe an oil level within the holding chamber 110 from an exterior of the hubcap assembly 100. Thus, the user may observe whether there is an adequate amount of oil inside the hubcap assembly 100 to determine if additional oil should be added. The user may also observe the color of the oil to determine the oil quality and thus whether the oil should be changed. As oil moves within the interior of the hubcap body 102 and through the filtration assembly 300, 300A during operation of the vehicle, the magnetic and/or barrier filter elements may remove contaminants from the oil and retain the contaminants on or within the filter elements. The design of the filtration assembly 300, 300A effectively removes contaminants from the oil to extend the life of the oil between oil changes and thus enhance bearing lubrication through extended periods of use.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1. A hubcap assembly comprising:
a hubcap body configured to be mounted onto a wheel hub, wherein the hubcap body has an interior wall that defines an oil enclosure, wherein the hubcap body has an open distal end;
a cap assembly configured to cap the open distal end of the hubcap body; and
a filtration assembly comprising at least one baffle plate attached to the interior wall of the hubcap body at a position that is axially inward from the cap assembly, wherein the at least one baffle plate has a plurality of openings extending through the at least one baffle plate, and
wherein the at least one baffle plate extends transversely across a width of the oil enclosure between surfaces of the interior wall on opposing sides of the oil enclosure, wherein a holding chamber is disposed between the at least one baffle plate and the cap assembly.

2. The hubcap assembly of claim 1, wherein the filtration assembly comprises two opposing baffle plates, wherein each respective one of the opposing baffle plates has a plurality of openings extending through the baffle plate, wherein the hubcap assembly further comprises a magnet disposed between the opposing baffle plates.

3. The hubcap assembly of claim 2, wherein the magnet is a ring-shaped magnet having an opening extending through the magnet.

4. The hubcap assembly of claim 2, wherein each respective one of the opposing baffle plates has a plurality of spacer elements each extending from a respective one of the opposing baffle plates toward the magnet, wherein the plurality of spacer elements is configured to retain the magnet in a fixed position between the opposing baffle plates.

5. The hubcap assembly of claim 1, wherein the filtration assembly comprises two opposing baffle plates, wherein each respective one of the opposing baffle plates has a plurality of openings extending through the baffle plate, wherein the hubcap assembly further comprises barrier filtration media disposed between the opposing baffle plates.

6. The hubcap assembly of claim 5, further comprising a magnet disposed between the opposing baffle plates.

7. The hubcap assembly of claim 1, wherein the filtration assembly comprises two opposing baffle plates, wherein each respective one of the opposing baffle plates has a plurality of openings extending through the baffle plate, wherein the opposing baffle plates are parallel to each other and attached to each other by a sidewall extending between the opposing baffle plates around an outer peripheral edge of each of the opposing baffle plates, wherein the opposing baffle plates and the sidewall define a unitary baffle assembly, wherein the baffle assembly comprises a magnet disposed between the opposing baffle plates, barrier filtration media disposed between the opposing baffle plates, or both a magnet and barrier filtration media disposed between the opposing baffle plates.

8. The hubcap assembly of claim 1, wherein the at least one baffle plate comprises a generally flat baffle element and a plurality of ring-shaped magnets each attached to the baffle element and each having an opening extending through the ring-shaped magnet, wherein each of the plurality of openings extending through the at least one baffle plate is defined by the opening extending through a respective one of the plurality of ring-shaped magnets.

9. The hubcap assembly of claim 1, wherein the at least one baffle plate comprises a generally flat baffle element and a plurality of magnetic elements attached to the baffle element.

10. The hubcap assembly of claim 1, wherein the hubcap body has a generally cylindrical shape.

11. The hubcap assembly of claim 1, wherein the at least one baffle plate has a generally circular shape that defines an outer peripheral edge of the at least one baffle plate, wherein the outer peripheral edge of the at least one baffle plate generally conforms to an interior shape of the interior wall of the oil enclosure such that the at least one baffle plate extends transversely across substantially all of a cross-sectional area of the oil enclosure.

12. The hubcap assembly of claim 1, wherein the cap assembly comprises a fastening ring, a transparent viewing window having an opening extending through the viewing window, and a plug, wherein the plug is configured to be installed within the opening in the viewing window to seal the opening in the viewing window.

13. The hubcap assembly of claim 12, wherein the plug has a pressure relief opening extending through the plug.

14. The hubcap assembly of claim 1, wherein the hubcap body has helical threads configured to mate with helical threads on the wheel hub.

15. The hubcap assembly of claim 1, wherein the hubcap body has a mounting flange having a plurality of openings extending through the mounting flange for fastening the mounting flange to the wheel hub.

16. A hubcap assembly comprising:
a hubcap body configured to be mounted onto a wheel hub, wherein the hubcap body has an interior wall that defines an oil enclosure, wherein the hubcap body has an open distal end;
a cap assembly configured to cap the open distal end of the hubcap body; and
a magnetic mesh filter comprising a plurality of woven wires, wherein the magnetic mesh filter is attached to the interior wall of the hubcap body at a position that is axially inward from the cap assembly, wherein the magnetic mesh filter has a plurality of openings extending through the magnetic mesh filter, and
wherein the magnetic mesh filter extends transversely across a width of the oil enclosure between surfaces of the interior wall on opposing sides of the oil enclosure, wherein a holding chamber is disposed between the magnetic mesh filter and the cap assembly.

17. The hubcap assembly of claim 16, further comprising a coated mesh filter disposed between the magnetic mesh filter and the cap assembly, wherein the coated mesh filter comprises a plurality of woven wires coated with a hydrophobic material configured to allow passage of oil through the coated mesh filter and to prevent passage of water through the coated mesh filter.

18. The hubcap assembly of claim 17, further comprising a depth filter disposed between the magnetic mesh filter and the coated mesh filter.

19. A hubcap assembly comprising:
a hubcap body configured to be mounted onto a wheel hub, wherein the hubcap body has an interior wall that defines an oil enclosure, wherein the hubcap body has an open distal end;
a cap assembly configured to cap the open distal end of the hubcap body; and
a filtration assembly comprising barrier filtration media disposed between two opposing support structures, wherein each of the opposing support structures comprises a plurality of magnetic elements arranged with a plurality of openings between the magnetic elements, wherein each of the opposing support structures is attached to the interior wall of the hubcap body at a position that is axially inward from the cap assembly,
wherein each of the opposing support structures extends transversely across a width of the oil enclosure between surfaces of the interior wall on opposing sides of the oil enclosure, wherein a holding chamber is disposed between one of the opposing support structures and the cap assembly.

20. The hubcap assembly of claim 19, wherein each of the opposing support structures comprises an outer support ring and a central support node, wherein each of the plurality of magnetic elements is attached to the outer support ring at one end of the magnetic element and to the central support node at an opposing end of the magnetic element.
